(19) United States
(12) Patent Application Publication
(10) Pub. No.: US 2004/0145539 A1
(43) Pub. Date: Jul. 29, 2004

(54) Image display for projecting image directly onto retina of wearer

(76) Inventors: Tatsuki Okamoto, Tokyo (JP); Yukio Sato, Tokyo (JP); Atsuhiro Sono, Tokyo (JP); Yasuhisa Nakamura, Tokyo (JP); Masayuki Miyawaki, Tokyo (JP); Atsushi Michimori, Tokyo (JP); Akinori Heishi, Tokyo (JP); Satoru Shiono, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/480,923

(22) PCT Filed: Jan. 31, 2003
(86) PCT No.: PCT/JP03/00953

(30) Foreign Application Priority Data
Feb. 1, 2002 (JP) 2002-25675
Jul. 9, 2002 (JP) 2002-199779

(51) Int. Cl. G09G 5/00

(52) U.S. Cl. 345/8

(57) ABSTRACT

A display device 1 has a light source 8, a scattering member for scattering light from the light source, an image plate 10 for transmitting the light scattered by the scattering plate and an optics 3 having a lens for focusing light from the image plate and transmitting the light to an eye of the viewer. According to the device, the image is focused on or around the pupil in the Maxwellian view condition, allowing even the myoptic and hyperoptic person to see the displayed image clearly.

### FIELD OF THE INVENTION

The present invention relates to a display apparatus for transmitting light through an image plate to form a visual image and then directly projecting the image onto a retina of a wearer of the apparatus.

### BACKGROUND OF THE INVENTION

FIG. 30 schematically illustrates a display apparatus for directly projecting an image onto a retina of a wearer or viewer, which is disclosed in the Japanese Patent Publication JP 2-136818 (A). The display apparatus has an optical system generally indicated by reference numeral 30. The optical system 30, which is supported by a frame not shown in front of an eye 31 of the wearer, has a plurality of components arranged toward the eye 31 of the wearer, i.e., a point source (light source) 32, an image plate made of a transmittal liquid crystal display (LCD) panel 33 and an eyepiece 34 or lens.

With the arrangement, light emitted from the point source 32 transmits the LCD panel 33. An image formed by light transmitted through the LCD panel 33 is focused by the eyepiece 34 at the pupil 35 and then transmitted through the crystalline lens 36 and the vitreous body 37 onto the retina 38. As described above, the display device is designed so that the point source 32 is focused on the pupil 35, which results in a good directivity of light. Also, even the myopic and hyperoptic wearer 31 can view the image displayed on the LCD panel 33 so clearly. However, even a slight movement of his or her eye causes his or her iris to shut the incident light and thereby disables him or her to see the image. For example, an average diameter of the pupil for adult in a dark place is about 7 mm. Then, a movement of the pupil of about ±3.5 mm or more disables the wearer to see the image. In the light place, the average diameter is reduced to about 4 mm. Therefore, a movement of the pupil of about ±2.0 mm or more disables the wearer to see the image.

Another technique has been disclosed in which a light source in the form of panel is positioned adjacent to the LCD panel. According to this arrangement, in particular for the image apparatus to be worn in front of the eye of the viewer, a sufficient space could not be ensured between the panel light source and the LCD panel due to a requirement of compactness. This causes that light transmitted from the LCD panel is scattered in all directions, which in turn causes light without directivity to be directed into the pupil. Therefore, an aberration must be cancelled in the optical system which leads light into the pupil, which results in a considerable complication of the optical system. Also, the viewer has to operate his or her vitreous body so that the image is focused on the retina. However, a distance between the LCD panel and the pupil is so limited that in particular a weak-eyed person has to wear glasses. Also, even when the wearer moves his or her eye away from the LCD panel in order to see an exterior, a part of light transmitted through the LCD panel enters into the pupil of the viewer, which prevents the viewer from seeing the exterior in a good manner.

Therefore, to solve these problems another display apparatus is disclosed in JP 8-211325 (A) in which a display panel has a number of point light sources arranged on the same plane. However, this arrangement is so complicated in structure and does not meet the compactness requirement.

Accordingly, a primary object of the present invention is to provide a display apparatus which enables the viewer or wearer to see an image clearly without any need to adjust his or her vitreous body. Another object of the present invention is to provide a display apparatus which allows the viewer to see an exterior clearly by moving his or her eye. Further object of the present invention is to provide a display apparatus of simple structure.

### SUMMARY OF THE INVENTION

To accomplish those objects, a display apparatus for projecting an image of an image plate onto a retina of a viewer has a a light source for emitting light; a scattering member for scattering the light from the light source; an image plate transmitting the light scattered by the scattering plate; and an optics having a lens for focusing light from the image plate and transmitting the light to an eye of the viewer, the optics being designed so that the light scattered by the scattering member is focused near a pupil of the viewer. This causes the image in the imaging plate is focused at or around the pupil in the Maxwellian view condition, allowing even the myopic and hyperoptic person to see the displayed image so clearly.

In another aspect of the present invention, the scattering member is a transmission or reflection scattering member. Also, in another aspect of the present invention, the scattering member is so constructed that its scattering factor decreases with an increase of a distance from an optical axis connecting between the light source and the pupil. According to the embodiment in which the scattering member is made of transmission scattering member, the structure of the display apparatus can be simplified. Also, according to the embodiment in which the scattering member is made of reflection scattering member, a dimension of the apparatus in the optical axis can be reduced.

In another aspect of the present invention, the scattering factor is adjusted by controlling an amount of a light scattering material included in the scattering member.

In another aspect of the present invention, the scattering factor is adjusted by controlling a surface roughness of the scattering member.

In another aspect of the present invention, the scattering member is so constructed that its reflection ratio decreases with an increase of a distance from an optical axis connecting the light source and the pupil.

In another aspect of the present invention, the reflection ratio is adjusted by controlling an amount of a light reflection material included in the scattering member.

In another aspect of the present invention, the reflection ratio is adjusted by controlling a surface roughness of the scattering member.

According to the apparatus, light with a substantially constant intensity is evenly projected onto the imaging plate, allowing the viewer to see images with constant light intensity within the image region even when the viewer moves his or her eyes.

In another aspect of the present invention, the scattering member is integrally defined in a housing of the apparatus. According to this display device, no specific part (scattering member) is needed for scattering light, reducing the number of necessary parts.

In another aspect of the present invention, the light source is a diode emitting ultraviolet light or blue light and the scattering member has a fluorescent material capable of changing light from the scattering member into white light.

In another aspect of the present invention, the light source is a combination of light sources emitting red, green and blue lights, respectively. This allows a field sequential liquid crystal display panel to be utilized.

In another aspect of the present invention, the light source is made of an electroluminescence. This allows the light source and the scattering member to be combined as a single element, reducing the number of parts.

In another aspect of the present invention, the scattering member is so sized that its horizontal length is greater than its vertical length. According to this device, the viewer can change his or her eyes to see external views simply by shifting his or her eyes upward or downward.

In another aspect of the present invention, a light transmitting direction is reversed between the light source and the imaging plate. This reduces the size of the apparatus in the direction parallel to the optical axis extending through the imaging plate.

In another aspect of the present invention, the device is a monocular display device in which the image is projected into one eye of the viewer.

In another aspect of the present invention, a display apparatus for projecting an image of an image plate onto a retina of a viewer has a light source for emitting light; a scattering member for scattering the light from the light source; an image plate for transmitting the light scattered by the scattering plate; and an optics having a lens for focusing light from the image plate and transmitting the light to an eye of the viewer, the optics being designed so that the scattering member takes an optically conjugated relationship with a pupil of the viewer.

It should be noted that the present application is based upon Japanese Patent Applications Nos. 2002-025675 and 2002-199779, which are incorporated herein by reference in their entireties.

### BRIEF DESCRIPTION OF DRAWINGS

FIG. 1A is a diagram showing an application of a display device according to a first embodiment;

FIG. 1B is a perspective view of the display apparatus shown in FIG. 1A;

FIG. 2 is a perspective view showing a structure of an optics incorporated in the display apparatus according to the first embodiment;

FIGS. 3A and 3B are plan and side elevational views showing the structure of the optics incorporated in the display apparatus according to the first embodiment;

FIGS. 4A and 4B are plan and side elevational views showing the structure of the optics incorporated in the display apparatus according to the second embodiment;

FIG. 5 is a diagram showing the structure of the optics incorporated in the display apparatus according to the third embodiment;

FIG. 6 is a diagram showing the structure of the optics incorporated in the display apparatus according to the fourth embodiment;

FIG. 7 is a diagram showing the structure of the optics incorporated in the display apparatus according to the fifth embodiment;

FIG. 8 is a diagram showing a graph indicating a distribution of light intensity illuminated from the light source into the scattering member;

FIG. 9 is a diagram showing a distribution of scattering factor of the scattering plate;

FIG. 10 is a diagram showing the structure of the optics incorporated in the display apparatus according to the sixth embodiment;

FIG. 11 is a diagram showing the structure of the optics incorporated in the display apparatus according to the seventh embodiment;

FIG. 12 is a diagram showing the structure of the optics incorporated in the display apparatus according to the eighth embodiment;

FIG. 13 is a diagram showing the structure of the optics incorporated in the display apparatus according to the ninth embodiment;

FIG. 14 is a diagram showing an application in which the display apparatus is used as a stadium viewer;

FIG. 15 is a diagram showing an application in which the display apparatus is used as a stadium viewer;

FIG. 16 is a diagram showing an application in which the display apparatus is used as an automated navigation system with a back viewer;

FIG. 17 is a diagram showing an application in which the display apparatus is used as a museum viewer;

FIG. 18 is a diagram showing an application in which the display apparatus is used as a worker's viewer;

FIG. 19 is a diagram showing an application in which the display apparatus is used in a changeable number authentication system;

FIG. 20 is a diagram showing an application in which the display apparatus is used in a wearable 3D or 2D theater;

FIG. 21 is a diagram showing an application in which the display apparatus is connected with a home monitoring camera system;

FIGS. 22A and 22B are diagrams showing applications in which the display apparatus is separated from the camera and is integrated with the camera, respectively;

FIG. 23 is a diagram showing a conventional operation using an endoscope;

FIG. 24 is a diagram showing an application in which the display apparatus is used as the monitor of the endoscope;

FIG. 25 is a diagram showing an application in which the display apparatus is used as the monitor of the endoscope;

FIG. 26 is a diagram showing an application in which the display apparatus is used as the monitor of the endoscope;

FIG. 27 is a diagram showing an application in which the display apparatus is used as the monitor of the endoscope;

FIG. 28 is a diagram showing an application in which the display apparatus is used as the monitor of the endoscope;

FIG. 29 is a diagram showing an application in which the display apparatus is used as a monitor of an emergency technician; and

FIG. 30 is a diagram showing a structure of the optics incorporated in the conventional display device.

### DETAILED DESCRIPTION OF THE PREFERRED EMBODIMENTS

Referring to the drawings, various embodiments of the present invention will be described hereinafter. Although various directional expressions including wordings such as “upper”, “lower”, “left”, “right” and/or combinations thereof are used as required in the following descriptions for the better understanding of the invention, they do not limit the scope of the invention.

First Embodiment

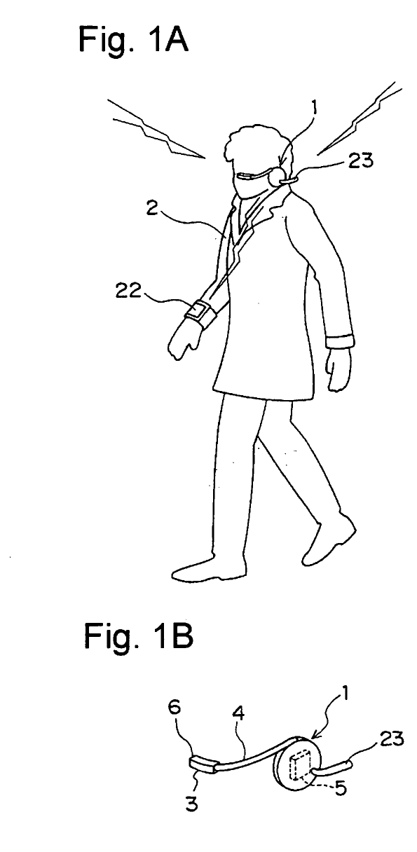

As shown in FIGS. 1A and 1B, a display device for transmitting an image directly onto a retina of the viewer or wearer, generally indicated by reference numeral 1, is worn in front of his or her eye, allowing the viewer to see an image including live-action and still images. Generally, the display device 1 has an optical unit 3 for projecting the image into the eye of the viewer 2, a frame 4 for supporting the optical unit 3 in a stable manner in front of viewer's eye and an image signal transmitter 5 for transmitting an image signal to the optical unit 3. Preferably, the transmitter 5 is installed in the frame 4. The structure and arrangement of the components illustrated in the drawing is simply one typical example and then the present invention is not limited thereto.

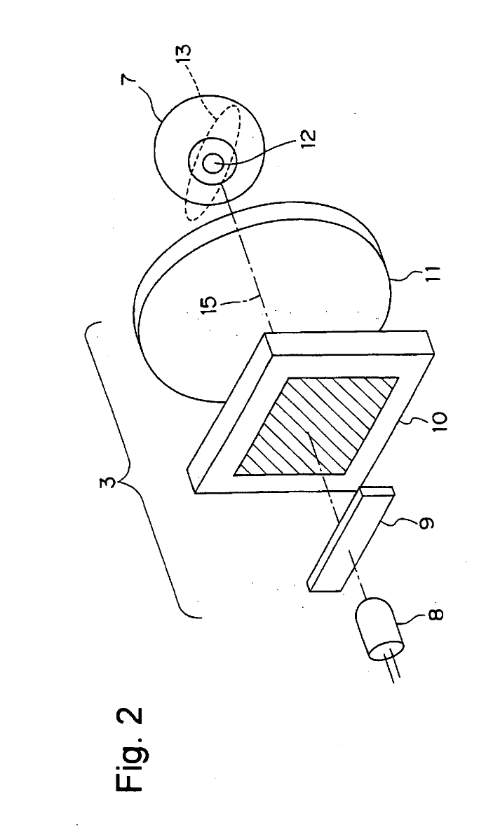

FIG. 2 schematically illustrates various components of the optical unit 3. As shown, a housing 6 (see FIG. 1) of the optical unit 3 accommodates a point light source 8, a transparent scattering member or plate 9, a transmission type imaging plate 10 and a lens or eyepiece 11 toward a left or right eye 7 of the viewer 2 or wearer

A variety of light emitting device may be used for the point source 8. Among other things, a light emitting diode (LED) is preferably used for the point source 8. Also, the point source 8 is not limited to the light source capable of emitting white light and it may be another light source capable of emitting ultraviolet light or blue light. Further, any light source capable of emitting light from a small region can be used for the point source 8.

The scattering plate 9 is made of material capable of scattering an incident light. In this embodiment, the scattering plate 9 is in the form of rectangular defined by longer horizontal edges and shorter vertical edges parallel to a body axis of the wearer. For example, the scattering plate 9 is made by adding small particles capable of scattering light (e.g., metal powder) into transparent material such as transparent glass and transparent plastic or by forming small recesses or irregularities on a surface of the transparent plate. The irregularities may be formed by the use of a mold which includes corresponding irregularities defined in its inner surface or by shot-blasting. The scattering plate 9 may be a paper or a ground glass. If the point source 8 uses a diode for emitting ultraviolet or blue light, a suitable fluorescent material for changing that light into white light is preferably contained in the scattering plate 9.

The imaging plate 10, which is a full-color or single-color transmission type liquid crystal display panel, is electrically connected to the signal transmitter 5 so that it receives an image signal from the transmitter 5 and then displays a corresponding image.

A spherical or aspheric convex lens may be used for the lens 11. The lens 11 may be made by a single lens or a combination lens made by plural lens.

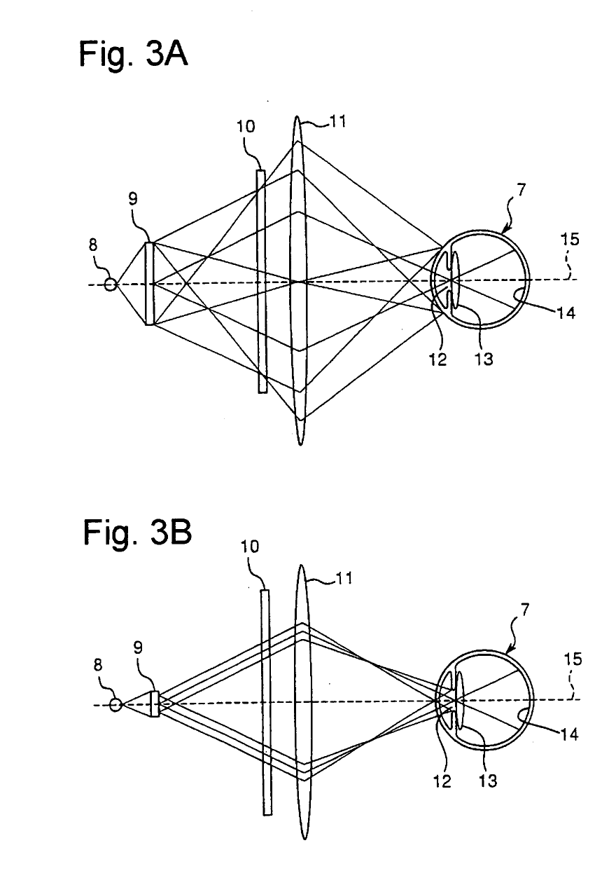

As shown in FIGS. 3A and 3B, the point source 8, scattering plate 9, imaging plate 10 and lens 11 are positioned so that, when the display device 1 is worn by the viewer 2, the scattering plate 9 takes an optically conjugated relationship with the pupil 12 of the viewer 2 with respect to the lens 11 or light from every portion of the scattering plate 9 can focus at or adjacent to the pupil 12. Also, a distance between the scattering plate 9 and the imaging plate 10 is determined so that, as indicated by dotted line in FIG. 2, an outline 13 of light to be focused at or around the pupil 12 draws an ellipse having a long horizontal axis and a short vertical axis. The distance may be about more than 15 mm.

With the display device so constructed, as shown in FIGS. 3A and 3B, light from the point source 8 is projected to the scattering plate 9 where it is scattered in all directions and then transmitted into the imaging plate 10. The imaging plate 10 receives the image to be displayed from the image transmitter 5, so that the corresponding image is displayed in the liquid crystal device. Subsequently, the image is projected by light from the scattering plate 9 into the lens 11. The image is then focused on or around the pupil 12 of the viewer 2 and projected onto the retina 14 of the viewer 2.

As described above, according to the display device 1 of this embodiment, the image displayed on the imaging plate 10 is focused on or around the pupil in the Maxwellian view condition. This allows even the myopic and hyperoptic person to see the displayed image so clearly without any control of his or her vitreous body 13 and without any aid of eyeglasses. Also, the viewer can superimpose the image projected on the retina of one eye on a real landscape viewed by the other eye without any difficulty.

Further, a suitable determination of the sizes of the scattering plate 9 and the imaging plate 10 and the distance between the scattering plate 9 and the imaging plate 10 causes only a small part of scattered light to travel into the imaging plate 10 and then into pupil 12. This mean that only light scattered from a limited region of the scattering plate 9 enters into the pupil 12. That is, a condition as if light is emitted from the point source is formed, which reduces disadvantageous eyestrain or asthenopia of the viewer.

Preferably the size of the scattering plate 9 is less than that of the imaging plate 10, which prevents the displayed image from entering into the pupil of the viewer when the viewer moves his or her eye out of the imaging plate 10.

Furthermore, in the previous embodiment the scattering plate 9 has a rectangular configuration and the distance between the scattering plate 9 and the imaging plate 10 is about 10 mm or more, more preferably about 15 mm or more. Then, as shown in FIGS. 2, 3A and 3B, the outline 13 of light projected at or around the pupil 12 draws an ellipse having a long horizontal axis and a short vertical axis. Therefore, as is evident from FIG. 3A, the image can be seen clearly even when the eye is moved from right to left and vice versa. On the other hand, as shown in FIG. 2, a slight upward or downward movement of the eye causes the light to move out of the pupil 12 and in turn allows the viewer to see the external landscape.

Second Embodiment

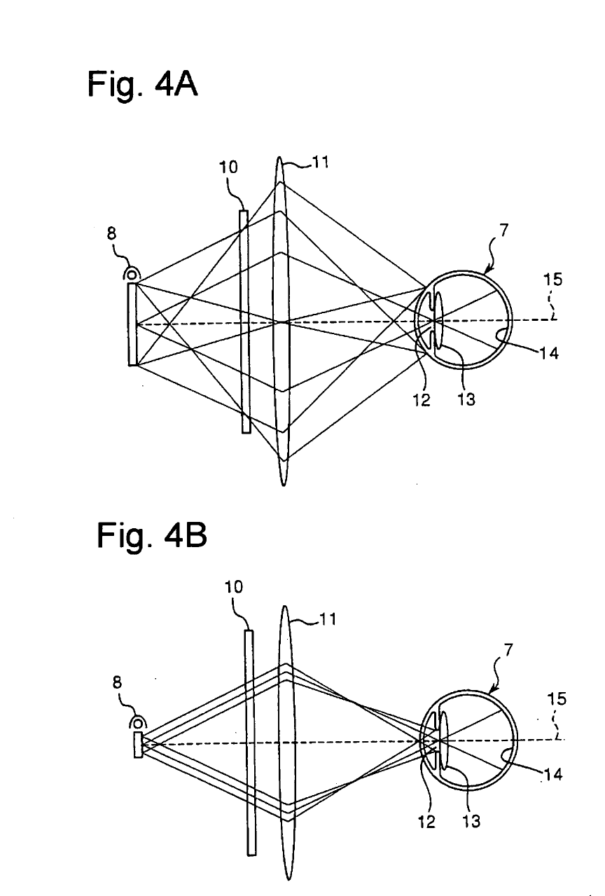

Although the point source is positioned so that light emitted therefrom enters into the major surface of the scattering plate in the previous embodiment, as shown in FIGS. 4A and 4B the light source 8 may be placed adjacent to a short or long edge of the scattering plate 9 so that light emitted from the light source 8 enters into the interior of the scattering plate 9 from its peripheral surface. In this instance, light reflects repeatedly at the opposing major surfaces of the scattering plate 9 to extend in its entirety and finally leaves through one major surface (right surface in the drawing).

In order to cause light to move out of the scattering plate through only one major surface adjacent to the viewer 2, the other major surface of the scattering plate and its peripheral surfaces except for one peripheral surface through which light enters into the interior of the scattering plate are preferably provided with a reflective coating or layer.

Also, a cylindrical light source may be used in this embodiment.

As can be seen from above, since the light source 8 is placed adjacent to the edge of the scattering plate 9 in this embodiment, a length of the display device in a direction of its optical axis can be reduced. Also, since the second embodiment has the same constructions as those of the first embodiment except for the arrangement of the light source and the structure of the scattering plate, all the advantages caused from the first embodiment can also be obtained from the second embodiment.

Third Embodiment

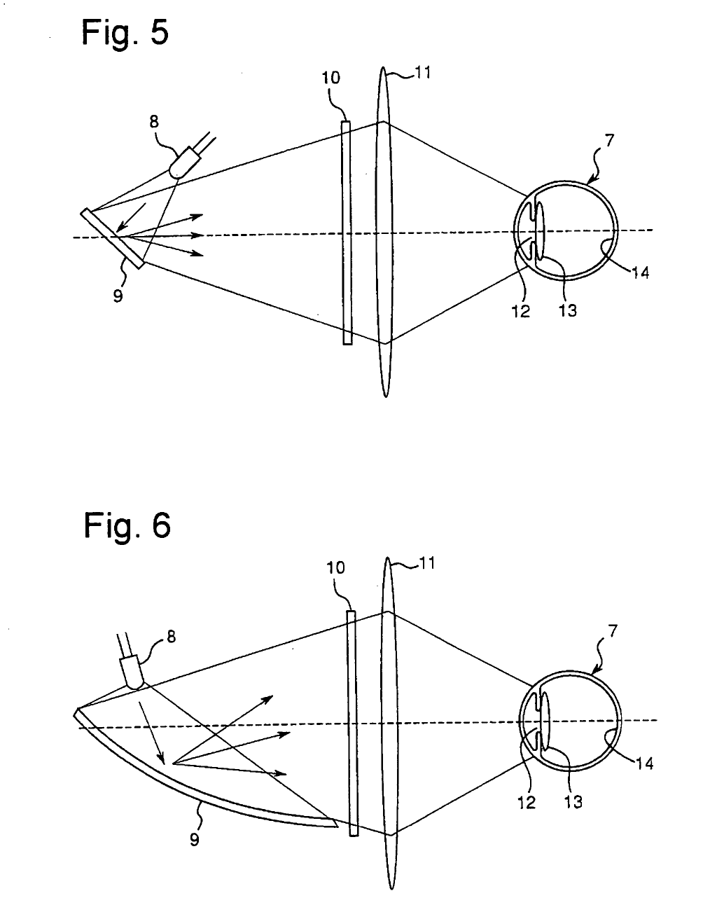

FIG. 5 shows another display device according to a third embodiment of the present invention, in which a rectangular reflective scattering plate is used for the scattering plate 9. In this embodiment, light from the light source 8 is scattered by the scattering plate 9 and then projected through the imaging plate 10 and the lens 11 onto the retina 12 of the viewer.

The reflective scattering plate may be a plate made of resin, glass or metal on which white or silver pigment or fluorescent material is applied, a plate made of resin or glass including white or silver pigment or fluorescent material mixed therein or a plate made from a ground glass.

According to this embodiment, the light source 8 can be placed on the same side of the scattering plate 9 as the imaging plate 10, which reduces the size of the display device in its optical axis direction.

Fourth Embodiment

FIG. 6 shows another display device according to a fourth embodiment of the present invention, in which the reflective scattering plate 9 is made from a curved plate which is concaved against the light source 8. This causes that light from the light source 8 is reflected and scattered at the surface of the scattering plate 9 and then transmitted through the imaging plate 10 and then lens 11 to the pupil 12 of the viewer.

As described above, similar to the third embodiment, an arrangement of the light source on the same side of the scattering plate 9 as the imaging plate 10 causes a length of the display device in its optical axis direction indicated by the dotted line to be reduced.

Fifth Embodiment

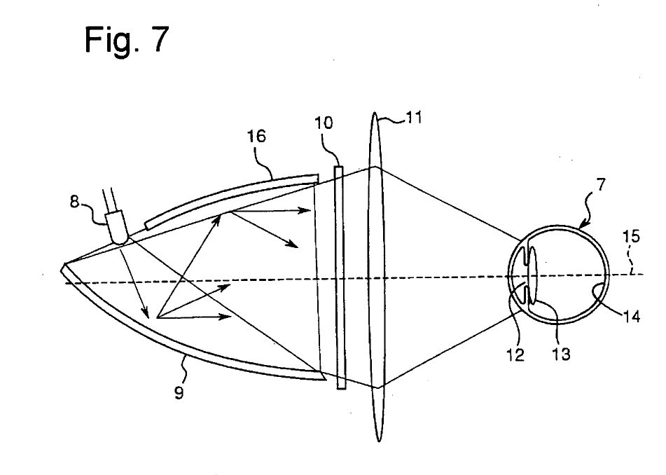

FIG. 7 shows another display device according to a fifth embodiment of the present invention, in which a first and a second curved reflective scattering plates 9 are provided on opposite sides of the optical axis 15. With the arrangement, a major part of light emitted from the light source 8 is reflected at the first reflective scattering plate. Then a part of the reflected light is directly transmitted into the imaging plate 10 and another part of the reflected light is again reflected at the second reflective scattering plate into the imaging plate 10. Light transmitted through the imaging plate 10 is then focused by the lens 11 on or around the pupil 12 of the viewer.

According to the display device of the fifth embodiment, light from the light source 8 is effectively projected to the imaging plate 10, allowing a light source emitting less light to be used.

Although two reflective scattering plates are used in this embodiment, the number of the plates and/or the arrangement thereof is not restrictive to the present invention.

Also, the reflective scattering plate may be replaced with a non-scattering reflective plate.

Sixth Embodiment

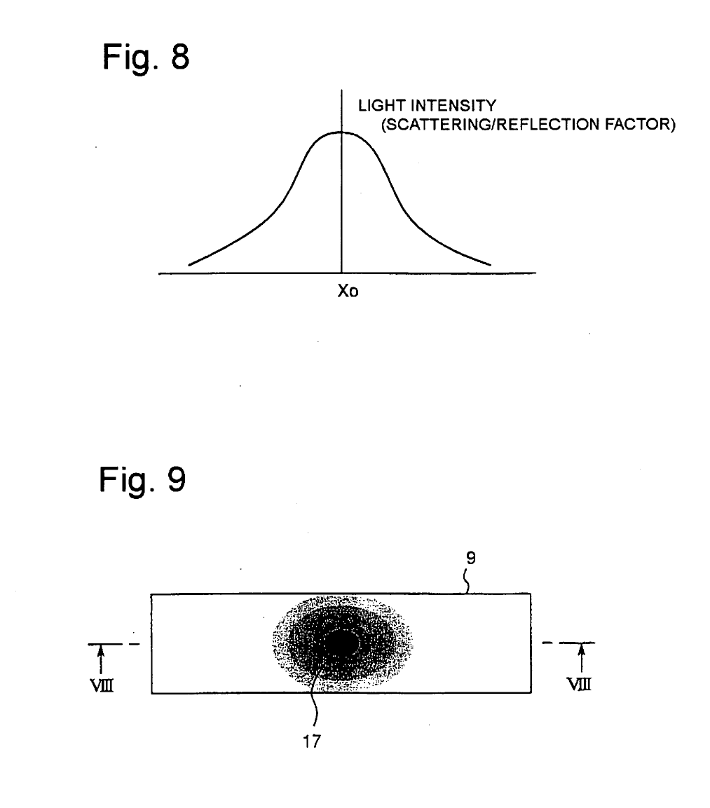

FIG. 8 shows a distribution of light which is measured on a surface of the plate positioned a certain distance away from the point source. As can be seen from this graph, a surface portion X₀, nearest to the point source receives a maximum amount of light and an amount of light received decreases exponentially with the increase of distance from an axis connecting between the point source and the nearest surface portion X₀. Notwithstanding, it is preferably for the scattering plate 9 to receive even light at every portion thereof in order to attain an even illumination of the imaging plate 10.

To this end, preferably the transmission scattering plate 9 described in FIGS. 1-3 has a scattering factor (ratio) of Gaussian distribution shown in FIG. 9 in which a maximum scattering factor exists on the optical axis 15 and the scattering ratio exponentially decreases with an increase of the distance from the optical axis 15. This also applies to the reflection scattering plate shown in FIGS. 5-7.

For the transmission scattering plate which is made by adding scattering material into the base material such as transparent glass, preferably an amount of added scattering material distributes in the Gaussian distribution so that the maximum scattering ratio exists on the optical axis 15. Also preferably, for the reflection scattering plate which is made by applying the scattering material on the base plate, an amount of applied scattering material distributes in the Gaussian distribution so that the maximum scattering ratio exists on the optical axis 15. Further, for the scattering plate which is made by forming small irregularities on the surface of the base plate, the similar scattering features can be attained by controlling the size or the density of the irregularities.

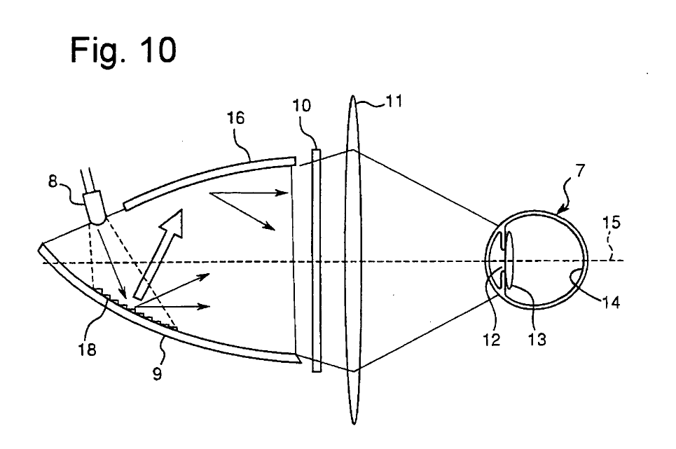

Also, for the display device with the curved scattering plate indicated in FIG. 7, as shown in FIG. 10 the first reflection scattering plate 9 is preferably provided at its region which receives a maximum amount of light from the light source 8 with a directional reflective scattering structure 18 made of parallel triangle grooves so that light received at the region reflects toward the second reflection scattering plate. This causes not only the scattering plate to be illuminated evenly but also the imaging plate 10 to be effectively illuminated by the second reflection scattering plate 9.

As described above, according to the display device with the scattering plate of which scattering ratio is increased at its light receiving region, the imaging plate 10 is illuminated uniformly. This allows the viewer 2 to see an image of even brightness even when the viewer moves his or her eye. Also, light from the light source is effectively used for the illumination of the imaging device, which in turn allows to use a light source with minimum energy consumption.

Seventh Embodiment

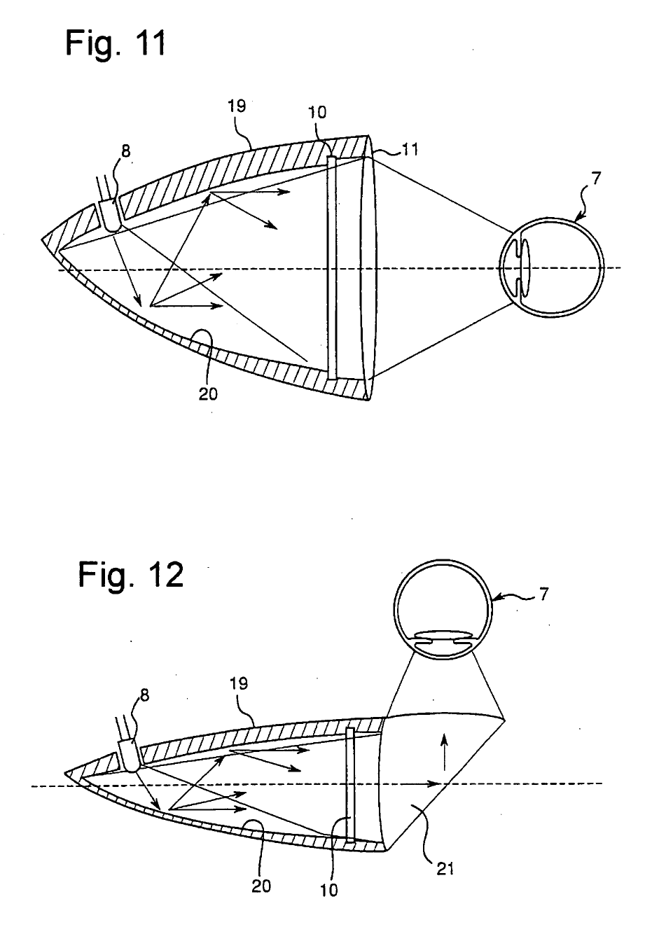

FIG. 11 shows another display device according to a seventh embodiment of the present invention, in which the light source 8, imaging plate 10 and lens 11 are supported by a hollow housing 19. The housing 19 is provided on its inner surface with a scattering layer 20 including a light scattering material. Also, an inner configuration of housing is so designed that a major part of light emitted from the light source 8 is transmitted through the imaging plate 10 and lens 11 and then concentrated on or around the pupil 12 of the viewer 2. The scattering layer 20 may be made by applying or depositing a coating material including scattering particles of metal (e.g., aluminum). Alternatively, a sheet with a scattering material may be affixed on the inner surface of the housing or the housing itself may be made of such scattering material.

As described above, since the scattering layer 20 is provided on the housing 19, no independent member is needed only for scattering light, which in turn reduces the number of components of the display device.

Eighth Embodiment

FIG. 12 shows another display device according to a seventh embodiment of the present invention which is a modification of the previous embodiment shown in FIG. 11. The display device 1 of this embodiment includes an optical element 21 which changes a path of light from the imaging plate 10 at about 90 degrees and then concentrates it on or around the pupil 12 of the viewer. Preferably the optical element 21 is a lens-prism integrated element in which each of the surfaces through which light moves into and out of the element defines convex lens. However, the optical element is not limited thereto and may be a combination of lens and mirror or mirrors.

With the display device 1 so constructed, a thickness of the device in a direction of the sight line of the viewer 2 can be reduced.

Ninth Embodiment

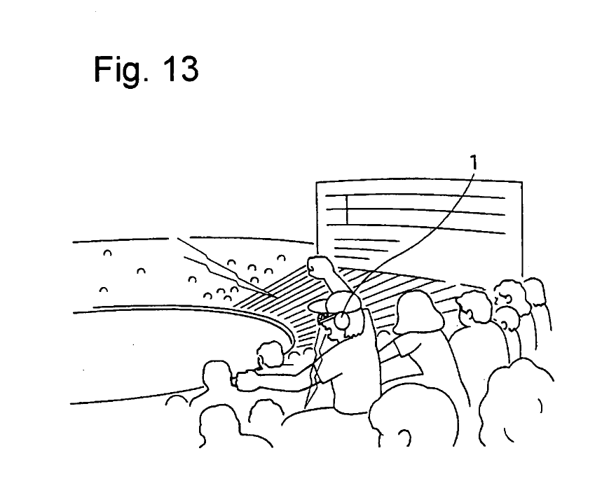

FIG. 13 shows another display device according to a ninth embodiment of the present invention, which is a modification of the previous embodiment shown in FIG. 12 and includes a reflection mirror 40 provided in the cylindrical housing 19. An interior of the housing 19 is so configured that light emitted from the light source 18 reflects at the reflection mirror 40 and also the inner surface of the housing 19 and thereby turned around into the imaging plate 10 and then the optical element 21.

With the arrangement, a size of the display device in the optical axis direction indicated by the dotted line and passing through the imaging plate 10 is reduced.

The reflection mirror 40 can be eliminated from the display device. In this instance, light from the light source 8 is turned around and toward the imaging plate 10 by the curved inner surface of the housing 19.

Although the light source 8 is directed in a direction opposite to the direction (i.e., optical axis) in which light is conveyed, an angle of the light source 8 with the optical axis is not limited to 180 degrees.

Tenth Embodiment

Although the light source is made of point source in the most previous embodiments, it may be replaced with a light source in the form of tube.

Although a color of light emitted from the light source is not restrictive to the invention, it is preferable to use the light source which emits white light, e.g., white LED.

Also, the light source is not limited to a single element emitting a single light and it may be a combination of plural elements emitting plural lights including blue, red and green lights. In this embodiment, an on-off timing of each element may be controlled independently. Also, a sequential liquid crystal display panel in which the displaying image is changed in synchronism with the change of emitting color may be used.

Further, although the light source and the scattering plate are provided as separate components in the previous embodiments, they can be realized by a single component such as electroluminecence. This reduces the number of components of the display device and facilitates its assembling.

Furthermore, although a variety of display devices have been described so far, the present invention may be either a monocular display devices or a binocular display device.

Applications

Several applications of the display device will be described hereinafter.

First Application

FIG. 1A shows a first application of the display device in which the display device is used for an output of a portable communication device. In this application, the display device 1 and the portable communication device (e.g., cellular phone) 22 are communicated with each other by a wire communication or a wireless communication, so that an image received by the communication device 22 through a communication network such Internet is transmitted to the display device 1 where it is displayed in the imaging plate. An audio device 23 having a microphone and an earphone may be connected to the communication device 22. In this instance, the display device 1 can be used as a wearable Web-phone, television and audio-visual device.

Second Application

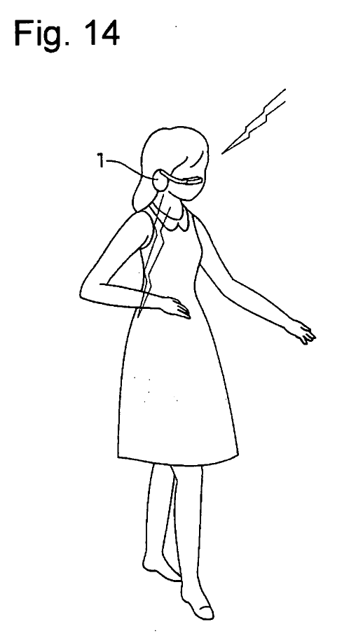

FIG. 14 shows a second application of the display device in which the display device is used for displaying an image transmitted from a transmitter equipped in the stadium or hall.

Generally, in a big sport stadium or concert hall an area which can be seen from one audience is so limited. On the other hand, such sport stadium and concert hall are equipped with a number of television cameras for shootings from various angles. In this situation, the display device can be used as a viewer or receiver of images transmitted from television cameras, so that the audience can watch any images picked up by the cameras in different angles, which is so enjoyable to the audience.

Third Application

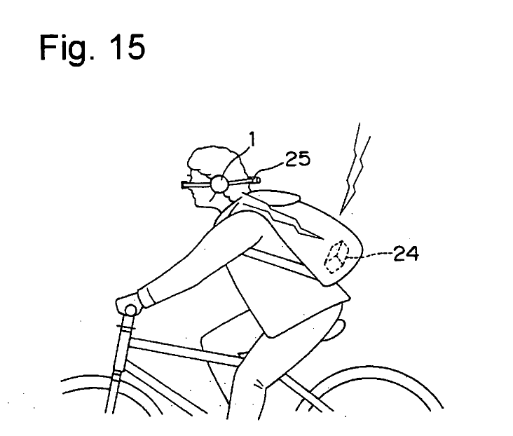

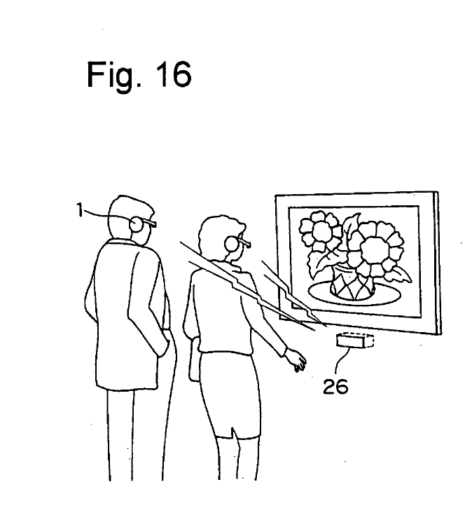

FIG. 15 shows a third application of the display device in which the display device is used as a wearable prompter through which a speaker can confirm the content of the presentation. In particular, even if any change has been made to the content of the presentation during presentation, the speaker can follow it while keeping his or her eye to the audience.

Fourth Application

FIG. 16 shows a fourth application of the display device in which the display device is used as an automatic navigation system equipped with a back viewer. In this application, the display device is connected with a transmitter 24 with a global positioning system (GPS) for transmitting digital information which shows a global position of the transmitter 24 on the associated digital map. A rear viewer or camera 25 is provided on the frame of the display device 1, so that an image picked up by the camera is also displayed in the display device. This causes the viewer to confirm any object, e.g., automobile and motorcycle, approaching from rearward.

Fifth Application

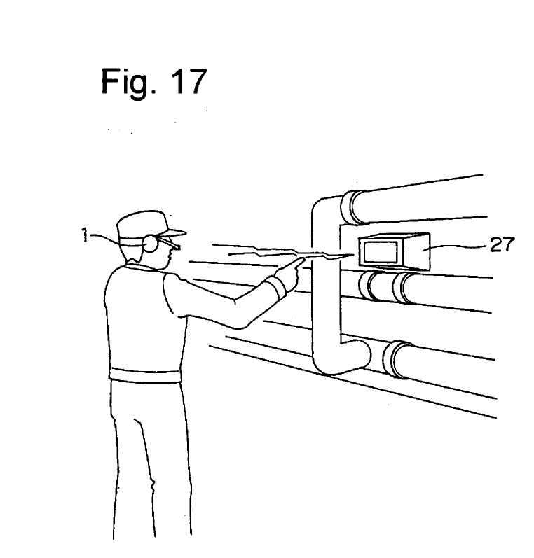

FIG. 17 shows a fifth application of the display device in which the display device is used as a museum viewer. In this application, a person wearing the display device can receive digital images or information (e.g., explanation) of the exhibition transmitted from a transmitter provided in the central control or adjacent to the exhibition (e.g., picture, sculpture and natural or artificial creations).

Sixth Application

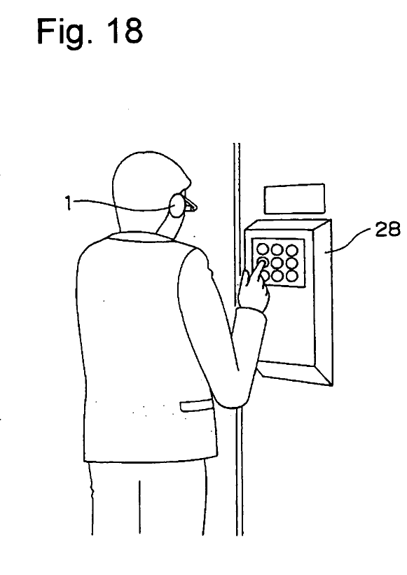

FIG. 18 shows a sixth application of the display device in which the display device is used for an operator's viewer. In this application, the operator wearing the display device performs aimed maintenance operations as he or she is confirming various checking items and procedures transmitted from a central control or a transmitter 27 provided near the site and then displayed on the display device. This allows even the unexperienced operator to perform the predetermined maintenance procedures without any mistake.

Seventh Application

FIG. 19 shows a seventh application of the display device in which the display device is used for a changeable number certification system. In this application, the certification system 28 changes or updates a personal ID or password for each person at regular time intervals and the updated ID or password is available through the display device. This arrangement improves the security of the certification system. Also, this allows to construct another security system by which, before entering into a room or building, a person wearing the display device can confirm the interior of the room or building through images transmitted from cameras equipped inside the room or building and then displayed in the display device. Those security systems may be combined with another certification system using a fingerprint recognition.

Eighth Application

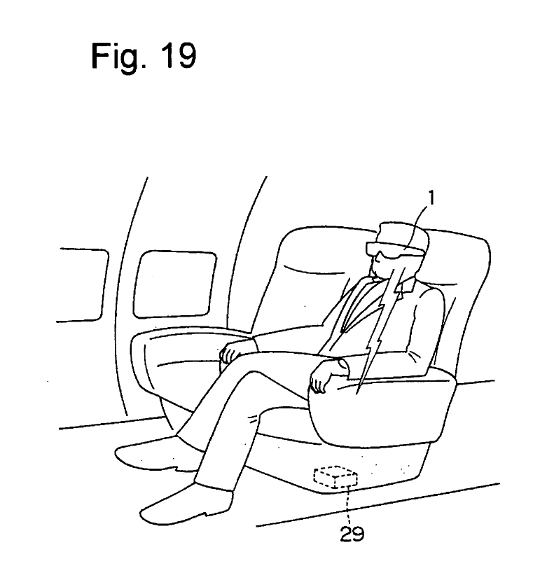

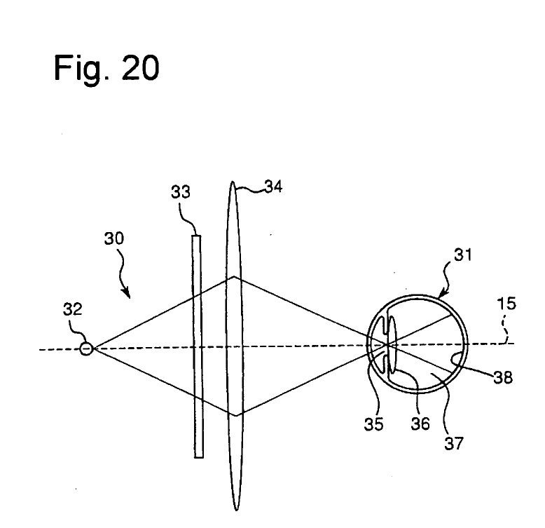

FIG. 20 shows an eighth application of the display device in which the display device is used for a wearable 3D or 2D theater. In this application, the display device receives 3D or 2D images from a transmitter 29 provided in the central control or around the seat in a vehicle (e.g., airplane, train, automobile) and other places (e.g., waiting room, inside or outside amusement facilities).

Ninth Application

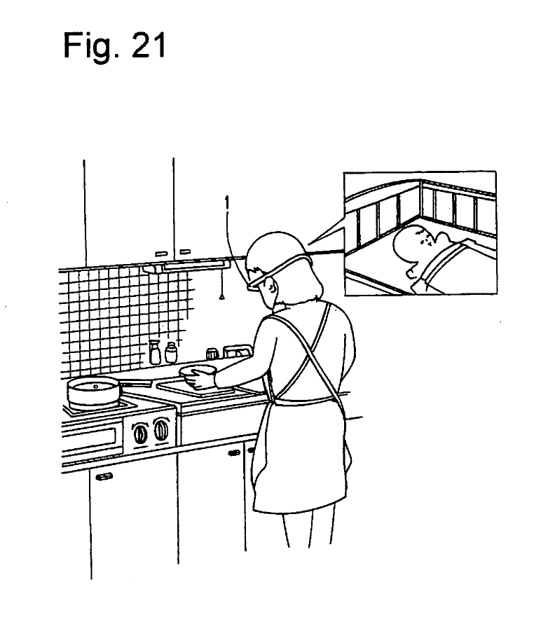

FIG. 21 shows a ninth application of the display device in which the display device is connected through a wireless communication technique with a monitoring camera or cameras not shown equipped in the house. In this application, a person wearing the display device can do various house works as he or she is watching a baby or aged individual in bed or a doorway.

Tenth Application

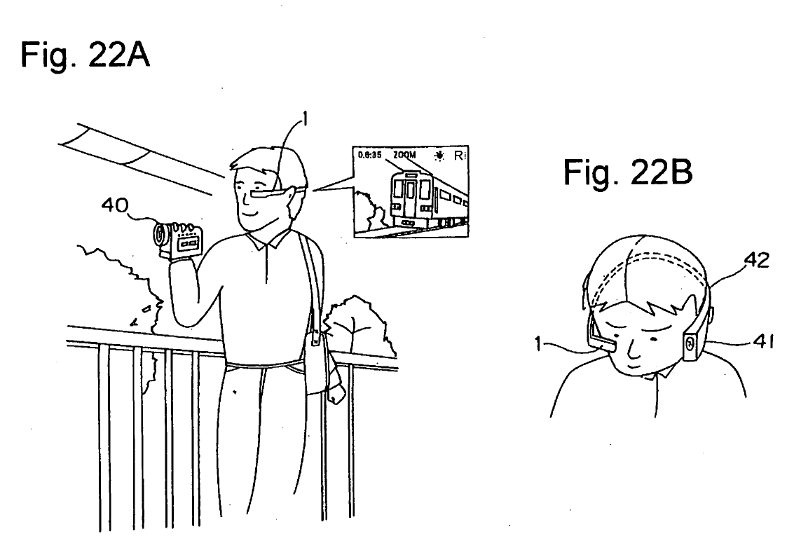

FIG. 22A shows a tenth application of the display device in which the display device 1 is physically separated from but electrically connected with the camera 40 so that an image picked up by the camera is transmitted to the display device where it is displayed. In this application, the camera 40 can be directed in any directions irrelevant to the orientation of the display device.

FIG. 22B shows a modification in which the display device 1 and the camera 41 are integrated in a U-shaped head band 42. This allows the wearer to see an enlarged image picked up by the camera 41. Then, this integrated device is preferably used for microscopic machining or manufacturing.

Eleventh Application

The display device may be used effectively for an auxiliary monitoring system in a medical field. For example, there have been performed microsurgery operations in the fields of cranial nerve surgery, ophthalmology, otorhinolaryngology, orthopedics and plastic surgery. In particular, the microsurgery operation have been employed routinely for subarachnoid hemorrhage (SAH), aneurysm and brain tumor operations. In such operations, the operator performs operations for suturing vascular each having a diameter of about one millimeter suture and cutting small tissues, for example, as he or she is watching an enlarged image picked up by the microscope. However, the microscope allows the operator to see only the exterior of the surgical site. In order to assist the microscope surgery, a suitable endoscope is inserted in the vascular tube, for example, so that the surgical site is imaged simultaneously from its inside.

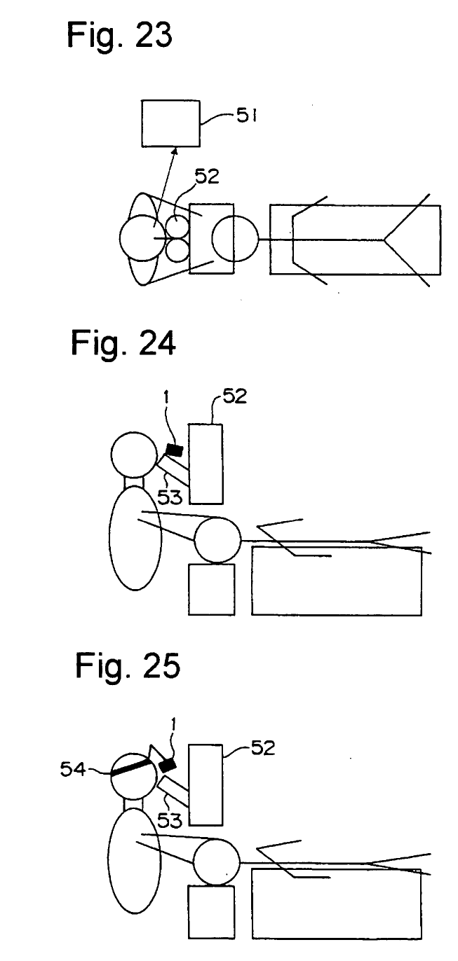

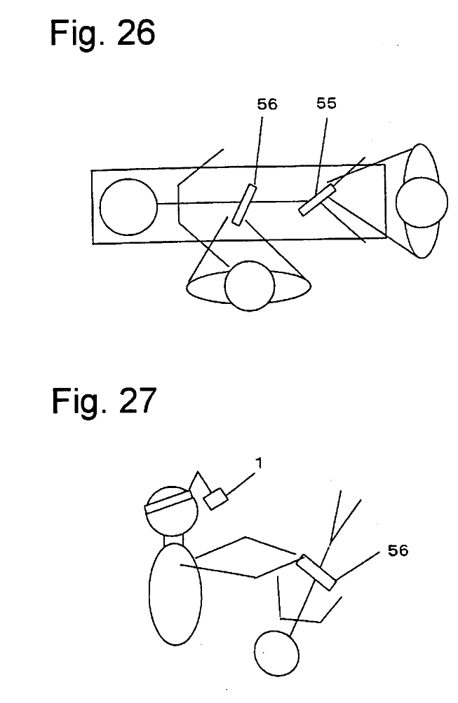

Typically, as shown in FIG. 23 the image picked up by the endoscope is displayed in the monitor 51 located beside the operator. This can result in a slight movement of the operator's head or shoulder when he or she looks at the displayed image in the monitor 51. This in turn causes an unwanted movement of the hands of the operator holding operation instruments, which may result a damage of the living tissue by the contact with the instruments. To prevent this, the operator is required to stop the operation and move the instruments away from the surgical site whenever he or she looks at the monitor.

Also, when the doctor moves his or her eyes from their viewing positions through the microscope to those through the monitor, he or she is required to perform a refocusing. To solve this problem, the doctor may be guided by his or her assistant who is looking at the monitor 51. This simply reduces the number of times that the doctor observes through the monitor.

The display device of the present invention can effectively be used to solve this problem. Specifically, as shown in FIG. 24 the display device 1 may be positioned above, below or beside the eyepiece 53 of the microscope 52 or as shown in FIG. 25 the display device 1 may be held adjacent the eyes of the operator using a head band 54 or other holder, so that the image picked up by the endoscope is displayed by the display device 1. This allows the operator to view the image captured by the endoscope with a slight movement of his or her eyes but without moving his or her head or body. This in turn eliminates any necessity to interrupt the operations whenever he or she sees the image caught by the endoscope. Currently, a new endoscope capable of displaying an object in a stereoscopic manner by way of three-dimensional images has been proposed so far. By the use of such endoscope, an arrangement of two displays above or below the eyes of the operator allows him or her to stereoscopically view the image caught by the three-dimensional endoscope through two display devices 1.

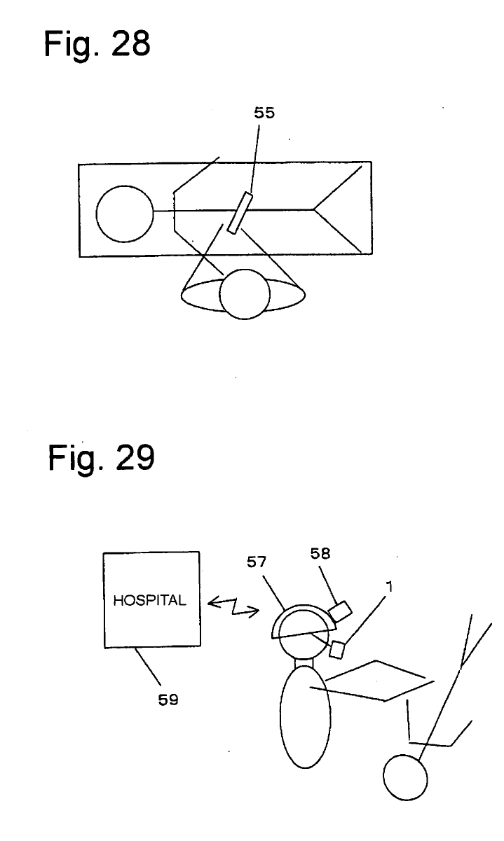

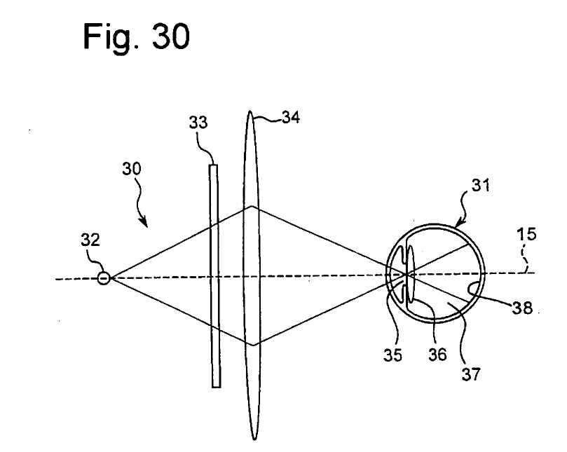

Also, as shown in FIGS. 27 and 28 a situation might occur in which two operators cooperate with each other while one operator holds the endoscope 55 and the other operator operates an operation tool 56 such as forceps as he or she views the image caught by the endoscope. The images caught by the endoscdpe 55 are displayed in the monitoring device provided nearby as is discussed in the previous embodiment, through which the operators works as they view the displaying images. Therefore, it has been stated that the operators are needed to face in the same direction for a long time, which is likely to cause the operators to experience fatigue and prohibits the operators to see both the images and the instruments at the same time. In this instance, the display device 1 may be mounted on the headband 54 worn by the operator. This allows the operator to view both the caught images and the actual instruments by slightly moving his or her eyes, which no longer needs the operator to fix his or her body during operation. Also, since the display device 1 has a deep depth of focus, even the operator with weak eyes can see both the images and the instruments so clearly.

When viewing and/or sampling lesions with the endoscope, as shown in FIG. 28 the operator can drive the endoscope as he or she looking at images caught by the endoscope inserted in the patient's body through the display device 1 held in front of his or her eye. Also, the display device 1 with the deep depth of focus causes the operator with weak eyes to see the images so clearly, which ensures a precise movement of the endoscope.

Besides, the display device 1 can be used as an assistance information terminal providing information necessary for the working operator such as X-ray and CAT scanner images caught before operation, three-dimensional model images of organs and blood test results, causing the operator to read the necessary, various information without using his or her hands. Also, the assistant or assistants wearing the display devices may be provided with necessary information such as instruction to prepare certain operational instruments.

At emergency medical service sites, as shown in FIG. 29 a helmet of the emergency technician may be provided with the display device 1 and the CCD camera 58 so that images caught by the camera 58 are transmitted to the hospital 58 and any instruction from the hospital 58 to the technician is indicated in the display device 1. This ensures the emergency technician to obtain the instruction from the hospital 58 through the display device 1. On the other hand, the doctors waiting in the hospital 58 can observe the procedures the emergency technician has made and the condition of the patient and, if necessary, provide necessary instruction to the emergency technician.

The display device of the present invention can be used for a medical communication between a doctor and a patient. For example, the doctor wearing the display device faces the patient as he or she talks with the patient or observes the patient while he or she obtains necessary information from the display device and also confirms input information through the display device.

Further, the display device may be used as a device for transmitting patient's images caught by a monitoring camera mounted in the clinical room to nurses.

Furthermore, the display device may be used as a diagnostic device. For example, the device may be used as a diagnostic instrument for a sight impair such as glaucoma, in which the display device worn by the patient displays a moving light spot of which the patient should follow.

1. A display apparatus for projecting an image of an image plate onto a retina of a viewer, comprising:
a light source for emitting light;
a scattering member for scattering the light from the light source;
an image plate transmitting the light scattered by the scattering plate; and
an optics having a lens for focusing light from the image plate and transmitting the light to an eye of the viewer, the optics being designed so that the light scattered by the scattering member is focused near a pupil of the viewer.

2. The apparatus of claim 1, wherein the scattering member is a transmission scattering member.

3. The apparatus of claim 1., wherein the scattering member is a reflection scattering member.

4. The apparatus in any one of claims 1 to 3, wherein the scattering member is so constructed that its scattering factor decreases with an increase of a distance from an optical axis connecting between the light source and the pupil.

5. The apparatus of claim 4, wherein the scattering factor is adjusted by controlling an amount of a light scattering material included in the scattering member.

6. The apparatus of claim 4, wherein the scattering factor is adjusted by controlling a surface roughness of the scattering member.

7. The apparatus of claim 3, wherein the scattering member is so constructed that its reflection ratio decreases with an increase of a distance from an optical axis connecting the light source and the pupil.

8. The apparatus of claim 7, wherein the reflection ratio is adjusted by controlling an amount of a light reflection material included in the scattering member.

9. The apparatus of claim 7, wherein the reflection ratio is adjusted by controlling a surface roughness of the scattering member.

10. The apparatus of claim 1, wherein the scattering member is integrally defined in a housing of the display apparatus.

11. The apparatus of claim 1, wherein the light source is a diode emitting ultraviolet light or blue light and the scattering member has a fluorescent material capable of changing light from the scattering member into white light.

12. The apparatus of claim 1, wherein the light source is a combination of light sources emitting red, green and blue lights, respectively.

13. The apparatus of claim 1, wherein the light source is made of an electroluminescence.

14. The apparatus of claim 1, wherein the scattering member is so sized that its horizontal length is greater than its vertical length.

15. The apparatus of claim 1, wherein a light transmitting direction is reversed between the light source and the imaging plate.

16. The apparatus of claim 1, wherein the device is a monocular display device in which the image is projected into one eye of the viewer.

17. The apparatus for projecting an image of an image plate onto a retina of a viewer, comprising:
a light source for emitting light;
a scattering member for scattering the light from the light source;
an image plate for transmitting the light scattered by the scattering plate; and
an optics having a lens for focusing light from the image plate and transmitting the light to an eye of the viewer, the optics being designed so that the scattering member takes an optically conjugated relationship with a pupil of the viewer.
